(19) United States
(12) Patent Application Publication
(10) Pub. No.: US 2016/0125345 A1
(43) Pub. Date: May 5, 2016

(54) SYSTEMS, DEVICES, AND METHODS FOR DETERMINING AN OPERATIONAL HEALTH SCORE

(71) Applicant: Wal-Mart Stores, Inc., Bentonville, AR (US)

(72) Inventors: Sayak Sachi Dulal Majumdar, Rogers, AR (US); Robert James Taylor, Rogers, AR (US); Christopher Scott Hoheisal, Pea Ridge, AR (US); Jeffrey Scott Cruz, Bentonville, AR (US); Aaron Vasgaard, Fayetteville, AR (US); Matthew Allen Jones, Bentonville, AR (US)

(73) Assignee: Wal-Mart Stores, Inc., Bentonville, AR (US)

(21) Appl. No.: 14/931,377

(22) Filed: Nov. 3, 2015

Related U.S. Application Data
(60) Provisional application No. 62/074,898, filed on Nov. 4, 2014.

(51) Int. Cl. G06Q 10/06; G06Q 10/08; G06F 17/30

(52) U.S. Cl. CPC G06Q 10/06393; G06F 17/30554; G06F 17/30528; G06F 17/3053; G06F 17/30241; G06Q 10/087

(57) ABSTRACT

Provided herein are methodologies, systems, and devices for calculating and displaying operational health scores based on key operational metrics that are used to evaluate on-shelf-availability. The measure of successful adoption of various key operational metrics is combined to produce an overall operational health score. The operational metrics can include, for example, pick completion, items binned, bin accuracy, manual counts, and manual picks. In some embodiments, these metrics can be weighted to reflect their relative impact on operational health and on-shelf-availability. The operational health scores can be compared with a target operational health score to determine whether each particular store is above or below the desired health score value. In some exemplary embodiments, a heat map can be displayed via a GUI that includes a number of store icons or color coded pins overlaid on a geographical map to represent the operational health score of the stores.

### RELATED APPLICATION

This application claims benefit of and priority to U.S. provisional application Ser. 62/074,898, filed. Nov. 4, 2014, which is incorporated herein by reference in its entirety.

### TECHNICAL FIELD

The present disclosure relates to techniques for managing inventory and determining operational health scores for stores. The present disclosure also relates to methodologies, systems and devices for presenting operational health score information via a graphical user interface.

### BACKGROUND OF THE TECHNOLOGY

In general, a store's performance can be audited in a number of ways. Certain conventional inventory identification techniques allow a user to audit stores and perform performance reviews but do not provide a comprehensive health score incorporating numerous operational health metrics.

### SUMMARY

Exemplary embodiments of the present disclosure provide inventory identification systems, devices and methods that facilitate determining and displaying operational health scores for stores of an enterprise based on operational metrics that are used to evaluate on-shelf-availability of inventory at the stores. The operational metrics can include, for example, pick completion, items binned, bin accuracy, manual counts, and manual picks. Once determined, the operational health score can be programmatically compared with a target operational health score to determine whether each particular store is above or below the desired health score value, and this operational health score can be displayed via a graphical user interface (GUI) generated and configured according to exemplary embodiments of the present disclosure.

In accordance with exemplary embodiments, a computer-implemented method is provided for translating physical activities within one or more stores into reference data corresponding to an operational health of the one or more stores. The method includes, in an inventory management system, receiving at a server of the inventory system, store activity data in an electronic format representing physical inventory processing tasks at a plurality of stores and corresponding to operational metrics associated with on-shelf-availability of products within the plurality of stores. The method also includes inputting the store activity data into an inventory rules engine programmed to generate and output a plurality of adoption scores based on the store activity data and one or more inventory rules, wherein each adoption score is a performance grade of one of the plurality of stores with respect to one of the operational metrics. The method also includes inputting the store activity data into an operational rules engine programmed to generate and output an operational health score for each of the plurality of stores, wherein each operational health score is statistically determined based on the plurality of adoption scores associated with one of the plurality of stores and one or more operational rules. The method also includes writing the store activity data, the plurality of adoption scores, and operational health score for each of the plurality of stores into a database. The method also includes constructing a database query via an electronic display device to retrieve from the database at least one of the store activity data, the plurality of adoption scores, or the operational health score. The method also includes transmitting at least one of the store activity data, the plurality of adoption scores, or operational health score from the database to the electronic display device. The method also includes rendering on the electronic display device a graphical user interface programmed to display a plurality of graphical indicators programmatically overlaid on a geographic map, each graphical indicator representative of the operational health score and geographical location of one of the plurality of stores.

In some embodiments, the graphical user interface is further programmed to display an on-shelf-availability score heat map including a plurality of store icons representing the on-shelf-availability score and geographical location of each of the plurality of stores. In some embodiments, the operational health score for each of the plurality of stores corresponds to a weighted sum of a pick completion adoption score (PCAS), a manual counts adoption score (MCAS), a manual pick adoption score (MPAS), an items binned adoption score (IBAS), and a bin accuracy adoption score (BAAS), wherein the PCAS is given most weight and the BAAS is given least weight. In some embodiments, the plurality of graphical indicators are color coded to represent the operational health score of a single store. In some embodiments, the plurality of graphical indicators include a plurality of user interface store icons selectable by a pointing device. In some embodiments, the pointing device includes at least one of a finger, pen, stylus, mouse cursor, or trackpad cursor. In some embodiments, the graphical user interface is further programmed to render, in response to a user selection of one of the store icons, at least one of an operational health score, process adoption score, a graph of operational metric data, an on-shelf-availability score, a process adoption by market, or a weekly adoption score corresponding to the selected store icon. In some embodiments, the plurality of graphical indicators are color coded to represent whether the operational health score corresponding to each store is above or below a threshold operational health score. In some embodiments, the store icons include an operational health score heat map of the plurality of stores. In some embodiments, the graphical user interface is further programmed to display a first listing of stores rated highest by the operational health score and a second listing of stores rated lowest by the operational health score. In some embodiments, the graphical user interface is further configured to zoom in on the heat map in response to a first user interface command, and zoom out on the heat map in response to a second user interface command. In some embodiments, the method further includes filtering the store activity data by data relating to at least one of a business unit, division, region, market, state, store, department, product category, or season.

In accordance with another exemplary embodiment, a system for translating physical activities within one or more stores into reference data corresponding to an operational health of the one or more stores is disclosed. The system includes a server of the inventory system programmed to receive store activity data in an electronic format representing physical inventory processing tasks at a plurality of stores and corresponding to operational metrics associated with on-shelf-availability of products within the plurality of stores; input the store activity data into an inventory rules engine programmed to generate and output a plurality of adoption scores based on the store activity data and one or more inventory rules, wherein each adoption score is a performance grade of one of the plurality of stores with respect to one of the operational metrics. The server is also configured to input the store activity data into an operational rules engine programmed to generate and output an operational health score for each of the plurality of stores, wherein each operational health score is statistically determined based on the plurality of adoption scores associated with one of the plurality of stores and one or more operational rules. The server is also configured to write the store activity data, the plurality of adoption scores, and operational health score for each of the plurality of stores into a database. The system also includes an electronic display device programmed to construct a database query requesting from the database at least one of the store activity data, the plurality of adoption scores, or the operational score. The electronic display device is also configured to receive at least one of the store activity data, the plurality of adoption scores, or the operational score from the database. The electronic display device is also configured to render, via a graphical user interface, a plurality of graphical indicators programmatically overlaid on a geographic map, each graphical indicator representative of the operational health score and geographical location of one of the plurality of stores.

In some embodiments, the graphical user interface is further programmed to display an on-shelf-availability score heat map including a plurality of on-shelf-availability store icons representing the on-shelf-availability score and geographical location of each of the plurality of stores. In some embodiments, the operational health score for each of the plurality of stores corresponds to a weighted sum of a pick completion adoption score (PCAS), a manual counts adoption score (MCAS), a manual pick adoption score (MPAS), an items binned adoption score (IBAS), and a bin accuracy adoption score (BAAS), wherein the PCAS is given most weight and the BAAS is given least weight. In some embodiments, the plurality of graphical indicators are color coded to represent the operational health score of a single store. In some embodiments, the plurality of graphical indicators include a plurality of user interface store icons selectable by a pointing device. In some embodiments, the pointing device includes at least one of a finger, pen, stylus, mouse cursor, or trackpad cursor. In some embodiments, the graphical user interface of the electronic display device is further programmed to render, in response to a user selection of one of the store icons, at least one of an operational health score, a process adoption score, a graph of operational metric data, an on-shelf-availability score, process adoption by market, or a weekly adoption score corresponding to the selected store icon. In some embodiments, the plurality of graphical indicators are color coded to represent whether the operational health score corresponding to each store is above or below a threshold operational health score. In some embodiments, the store icons include an operational health score heat map of the plurality of stores. In some embodiments, the graphical user interface is further programmed to zoom in on the heat map in response to a first user interface command, and zoom out on the heat map in response to a second user interface command. In some embodiments, the graphical user interface of the electronic display device is further programmed to display a first listing of stores rated highest by the operational health score, and display a second listing of stores rated lowest by the operational health score.

In accordance with another exemplary embodiment, a non-transitory computer readable medium storing instructions executable by a processing device, is disclosed, wherein execution of the instructions causes the processing device to implement a method for translating physical activities within one or more stores into reference data corresponding to an operational health of the one or more stores. The method for identifying inventory includes receiving at a server store activity data in an electronic format representing physical inventory processing tasks at the plurality of stores and corresponding to operational metrics associated with on-shelf-availability of products within the plurality of stores. The method also includes inputting the store activity data into an inventory rules engine programmed to generate and output a plurality of adoption scores based on the store activity data and one or more inventory rules, wherein each adoption score is a performance grade of one of the plurality of stores with respect to one of the operational metrics. The method also includes inputting the store activity data into an operational rules engine programmed to generate and output an operational health score for each of the plurality of stores, wherein each operational health score is statistically determined based on the plurality of adoption scores associated with one of the plurality of stores and one or more operational rules. The method also includes writing the store activity data, the plurality of adoption scores, and operational health score for each of the plurality of stores into a database. The method also includes constructing a database query via an electronic display device requesting from the database at least one of the store activity data, the plurality of adoption scores, or the operational health score. The method also includes transmitting at least one of the store activity data, the plurality of adoption scores, or operational health score from the database to the electronic display device. The method also includes rendering a graphical user interface on the electronic display device programmed to display a plurality of graphical indicators programmatically overlaid on a geographic map, each graphical indicator representative of the operational health score and geographical location of one of the plurality of stores.

In some embodiments, the graphical user interface is further programmed to display an on-shelf-availability score heat map including a plurality of on-shelf-availability store icons representing the on-shelf-availability score and geographical location of each of the plurality of stores. In some embodiments, the operational health score for each of the plurality of stores corresponds to a weighted sum of a pick completion adoption score (PCAS), a manual counts adoption score (MCAS), a manual pick adoption score (MPAS), an items binned adoption score (IBAS), and a bin accuracy adoption score (BAAS), wherein the PCAS is given most weight and the BAAS is given least weight. In some embodiments, the plurality of graphical indicators are color coded to represent the operational health score of a single store. In some embodiments, the plurality of graphical indicators include a plurality of user interface store icons selectable by a pointing device. In some embodiments, the pointing device includes at least one of a finger, pen, stylus, mouse cursor, or trackpad cursor. In some embodiments, the graphical user interface is further programmed to render, in response to a user selection of one of the store icons, at least one of an operational health score, process adoption score, a graph of operational metric data, an on-shelf-availability score, a process adoption by market, or a weekly adoption score corresponding to the selected store icon. In some embodiments, the plurality of graphical indicators are color coded to represent whether the operational health score corresponding to each store is above or below a threshold operational health score. In some embodiments, the store icons include an operational health score heat map of the plurality of stores. In some embodiments, the graphical user interface is further programmed to display a first listing of stores rated highest by the operational health score and a second listing of stores rated lowest by the operational health score. In some embodiments, the graphical user interface is further configured to zoom in on the heat map in response to a first user interface command, and zoom out on the heat map in response to a second user interface command. In some embodiments, the method for identifying inventory further includes filtering the store activity data by data relating to at least one of a business unit, division, region, market, state, store, department, product category, or season.

Any combination or permutation of embodiments is envisioned.

### BRIEF DESCRIPTION OF THE DRAWINGS

The foregoing and other features and advantages provided by the present disclosure will be more fully understood from the following description of exemplary embodiments when read together with the accompanying drawings, in which:

FIG. 1 is a flowchart illustrating an exemplary method for identifying inventory, according to embodiments of the present disclosure.

FIG. 2 is a block diagram of an exemplary system that can perform exemplary processes in accordance with exemplary embodiments of the present disclosure.

FIG. 3 is a block diagram of an exemplary computing device that can be used to perform exemplary processes in accordance with exemplary embodiments of the present disclosure.

FIG. 4 is a diagram of an exemplary network environment suitable for a distributed implementation of exemplary embodiments of the present disclosure.

FIG. 5 depicts an exemplary user interface for displaying on-shelf-availability of inventory using a heat map, according to embodiments of the present disclosure.

FIG. 6 depicts an exemplary user interface for displaying store activity data and operational health metric data, according to embodiments of the present disclosure.

FIG. 7 depicts an exemplary user interface for zooming in on an area of a heat map, according to embodiments of the present disclosure.

FIG. 8 depicts an exemplary user interface for comparing inventory on-shelf-availability scores, according to embodiments of the present disclosure.

FIG. 9 depicts an exemplary user interface for displaying a top and bottom stores list, according to embodiments of the present disclosure.

FIG. 10 depicts an exemplary user interface for displaying operational health scores of stores using a heat map, according to embodiments of the present disclosure.

FIG. 11 depicts an exemplary user interface for displaying store activity data and store adoption score data, according to embodiments of the present disclosure.

FIG. 12 is depicts an exemplary user interface for displaying process adoption data by market, according to embodiments of the present disclosure.

FIG. 13 depicts an exemplary user interface for displaying store activity data and key process adoption metrics, according to embodiments of the present disclosure.

### DETAILED DESCRIPTION

### I. Definitions

Certain terms are defined below to facilitate understanding of exemplary embodiments.

As used herein, the term “pick completion” means a percentage of picks (e.g., items picked from a storage room and moved onto the sales floor) completed compared to a total picks that were generated by inventory management system (IMS).

As used herein, the term “items binned” means a number of times or actions of putting items back in a storage room bin or returning items to a storage location.

As used herein, the term “manual picks” means a number of picks for items that were generated manually by a sales associate, in contrast to a “system pick” that is generated by an IMS automatically based on one or more business rules.

As used herein, the term “manual count” means an action of counting a quantity of an item in a store when the action is initiated by a sales associate. In contrast, an “automatic count” is initiated by an IMS based on one or more business rules, but the counting can still be completed by a sales associate.

As used herein, the term “bin accuracy” means a score determined by a physical audit of a bin or storage location by a sales associate comparing expected content to actual content.

As used herein, the term “adoption score” means a score assigned to each store based on that particular store's performance with respect to an operational health metric.

### II. General Overview

Provided herein are methodologies, systems, apparatus, and non-transitory computer-readable media for generating and presenting to a user, via a graphical user interface (GUI), a number of store performance scores that are generated based on store activity data and product information collected from a number of stores or businesses. In exemplary embodiments, the store activity data may be collected using one or more sensors, such as barcode readers and/or RFID readers. The types of store activity data collected and used to generate the store performance scores, also known as operational health scores, may include data relating to various operational metrics that significantly correlate to the on-shelf-availability of products within the stores. Such operational metrics can include, for example, pick completion, items binned, bin accuracy, manual counts, and manual picks. In some embodiments, these metrics can be weighted to reflect their relative impact on the operational health of a store and/or the on-shelf-availability of products within a store. Once generated, the operational health scores can be programmatically compared with a target operational health score to determine whether each particular store is above or below the desired health score value. In alternative embodiments, the operational health score of one store can be programmatically compared with the operational health score of one or more additional stores in order to determine the relative performance of two or more stores.

According to conventional methodologies, a store's performance would have to be analyzed multiple times with respect to each individual operational metric. Such techniques are inefficient in that they do not provide a single score representative of the overall operational health of a store. Exemplary embodiments address this shortcoming in conventional inventory management systems by generating a single operational health score for a store that combines multiple action-tracking or operational health metrics in a weighted distribution to determine the overall health and performance of a retail operation. This operational health score can then be presented on an electronic display device as a graphical indicator on a geographic map. Thus, the operational health of numerous stores can be efficiently displayed and visually compared against the operational health of other stores and/or against a target health score.

In exemplary embodiments, a heat map can be displayed via a GUI that can be generated and configured to include a number of store icons or color coded pins to represent the operational health scores of a number of stores. For example, a store with a health score above the target health score can have a green icon while a store with a health score below the target health score can have an orange or red icon. A similar heat map can be displayed corresponding to the on-shelf-availability score of each store. The health score heat map and on-shelf-availability score heat map can be filtered to include data from a specific business unit, division, region, market, state, store, department, category, etc. The GUI can also display a listing of the stores with the best health scores and a listing of the stores with the worst health scores. The GUI can also allow a user to zoom in or out on the heat map using one or more touch screen gestures or other user input commands.

In some exemplary embodiments, a separate user interface can be provided for each type of inventory identification, for example, a first user interface for providing a store health score heat map, a second user interface for providing a top and bottom stores list, a third user interface for providing a metrics tab, a fourth user interface for providing an on-shelf-availability heat map, and the like. In other exemplary embodiments, a single user interface can be used to perform two or more inventory identification operations.

Exemplary embodiments are described below with reference to the drawings. One of ordinary skill in the art will recognize that exemplary embodiments are not limited to the illustrative embodiments, and that components of exemplary systems, devices and methods are not limited to the illustrative embodiments described below.

### III. Exemplary Inventory Identification Operations

Exemplary systems, devices, methods, and non-transitory computer-readable media can be used to define and execute one or more inventory identification operations in which operational health scores are determined for one or more stores based on a number of different operational health metrics. The operational health scores can be presented to a user via a GUI that displays a number of graphical indicators or icons overlaid on a virtual geographic map.

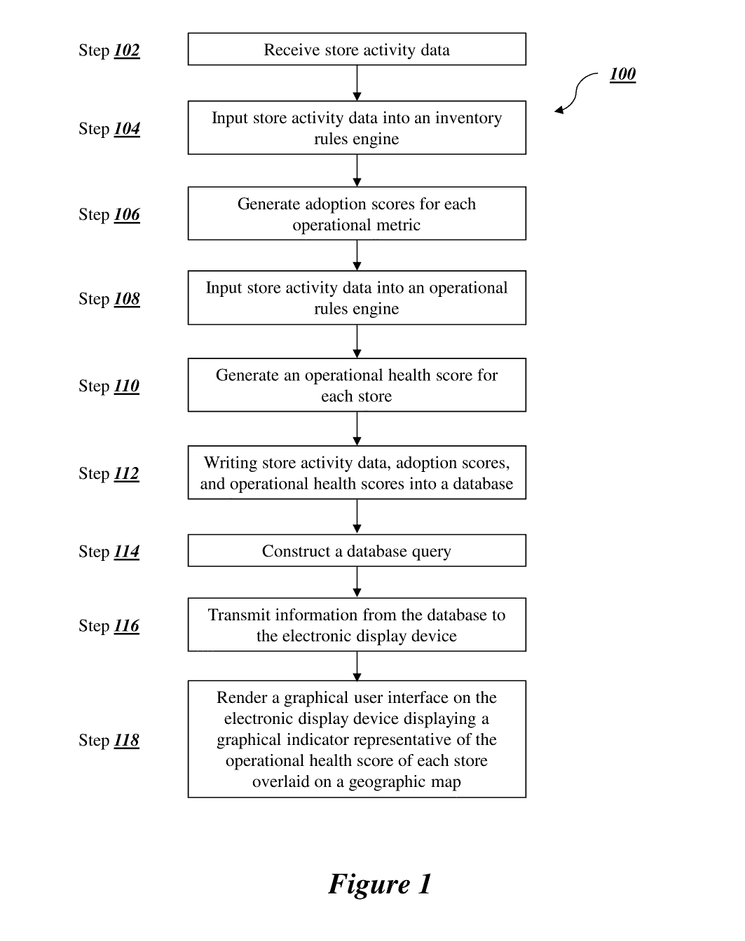

FIG. 1 is a flowchart that illustrates an exemplary method 100 for translating physical activities within one or more stores into reference data corresponding to an operational health of the one or more stores, and for rendering an exemplary graphical user interface configured to allow a user to view graphical indicators representative of the operational health of the stores overlaid on a virtual map.

In step 102, an exemplary IMS can be programmed to receive store activity data from a plurality of stores. The store activity data is received in an electronic format and is representative of physical inventory processing tasks at each of the stores and corresponds to operational metrics associated with on-shelf-availability of products within those stores. In exemplary embodiments, the store activity data can correspond to operational metrics such as, bin accuracy, pick completion, manual counts, manual picks, items binned, etc. Certain metrics can include chronologically associated relationships between certain operational health metrics in order to determine whether the desired order of operations is being implemented. The store activity data can be input manually by a sales associate or store manager at a computer terminal within each of the stores, or can be detected automatically or manually by one or more sensors configured to monitor and report certain store activity data. In some embodiments, one or more sensors, such as, a handheld barcode reader, a barcode reader at a point of sale terminal, a RFID reader, etc. may be used to collect store activity data and product information at each of the stores.

In step 104, an exemplary IMS can input store activity data into an inventory rules engine. The inventory rules engine can be programmed to generate an adoption score for each of a plurality of stores based on each operational metric described above and one more inventory rules. For example, in one embodiment the inventory rules engine is programmed to execute inventory rules to determine a pick completion adoption score (PCAS), an items binned adoption score (IBAS), a bin accuracy adoption score (BAAS), a manual counts adoption score (MCAS), a manual picks adoption score (MPAS), or any combination thereof. Each adoption score that is determined for a store can correspond to the store's performance with respect to an operational health metric. For example, a higher PCAS corresponds to a high ratio of completed picks compared to generated picks, a high BAAS corresponds to a high ratio of actual bin contents compared to expected bin contents, a high MCAS corresponds to a low ratio of non-ideal counts (sum of all manual counts performed during peak stocking and/or shopping times) compared to manual counts (sum of all counts performed), a high MPAS corresponds to a high ratio of ideal picks (number of manual picks performed during the ideal picking time period) compared to the total number of manual picks performed, and a high IBAS corresponds to a high ratio of items binned during the ideal binning time period compared to the total number of items binned.

In step 106, an exemplary IMS can generate adoption scores for each operational metric according to the rules or algorithms described below. In some embodiments, the inventory rules engine is programmed to calculate a PCAS, IBAS, MCAS, MPAS, and BAAS according to a series of operational rules or algorithms.

In example embodiments, the inventory rules engine can generate a PCAS according to the following algorithm:

Pick_Completion = (Picks Worked/Picks Generated) x 100
if [Pick_Completion] is null then 0

elseif [Pick_Completion] > 95 then 10
elseif [Pick_Completion] > 90 AND [Pick_Completion] <=95 then 8
elseif [Pick_Completion] > 80 AND [Pick_Completion] <=90 then 6
elseif [Pick_Completion] > 70 AND [Pick_Completion] <=80 then 5
elseif [Pick_Completion] > 60 AND [Pick_Completion] <=70 then 4
elseif [Pick_Completion] <=60 then 3

end

As provided above, the PCAS can be generated based on a Pick_Completion score, which is determined by the ratio of picks worked divided by picks generated. For example, if the ratio of picks worked divided by picks generated is zero, the PCAS can be zero; if the ratio of picks worked divided by picks generated is greater than 0.95, the PCAS can be 10; if the ratio of picks worked divided by picks completed is between 0.95 and 0.90, the PCAS can be 8; if the ratio of picks worked divided by picks completed is between 0.90 and 0.80, the PCAS can be 6; if the ratio of picks worked divided by picks completed is between 0.80 and 0.70, the PCAS can be 5; if the ratio of picks worked divided by picks completed is between 0.70 and 0.60, the PCAS can be 4; and if the ratio of picks worked divided by picks completed is below 0.60, the PCAS can be 3. As will be appreciated, the various Pick_Completion score ranges (e.g., a PCAS of 5 for the range of Pick_Completion scores between 70-80) are provided for illustration purposes only and can be altered based on the characteristics of a particular store, season, region, or any other suitable factor.

In example embodiments, the inventory rules engine generates an IBAS according to the following algorithm:

Ideal_Binned = Number of items binned before 8:00 AM by store each week.
Items_Binned = Total items binned all day by store each week.
Binned_Adoption = (SUM([Ideal_Binned]) / SUM([Items_Binned]) ) * 100
if [Binned_Adoption] is null then 0

elseif [Binned_Adoption] > 70 then 10
elseif [Binned_Adoption] > 60 AND [Binned_Adoption] <=70 then 8
elseif [Binned_Adoption] > 50 AND [Binned_Adoption] <=60 then 6
elseif [Binned_Adoption] > 40 AND [Binned_Adoption] <=50 then 5
elseif [Binned_Adoption] > 30 AND [Binned_Adoption] <=40 then 4
elseif [Binned_Adoption] <=30 then 2

end

As provided above, the IBAS can be generated based on the Binned_Adoption score, which is generated by determining the sum of all items binned in a week during the ideal time period for binning items, divided by the sum of all items binned that week, and multiplying that ratio by 100. For example, if the Binned_Adoption score is greater than 70, the IBAS can be 10; if the Binned_Adoption score is between 60 and 70, the IBAS can be 8; if the Binned_Adoption score is between 50 and 60, the IBAS can be 6; if the Binned_Adoption score is between 40 and 50, the IBAS can be 5; if the Binned_Adoption score is between 30 and 40, the IBAS can be 4; if the Binned_Adoption score is below 30, the IBAS can be 2; and if the Binned_Adoption score is zero the IBAS can be zero. As will be appreciated, the various Binned_Adoption score ranges (e.g., a IBAS of 5 for the range of binned adoption scores between 40-50) are provided for illustration purposes only and can be altered based on the characteristics of a particular store, season, region, etc. Likewise, the identification of ideal binned items can vary based on similar factors. For example, in this particular embodiment, the Ideal_Binned score is determined by the number of items binned before 8:00 AM because generally it is impractical for sales associates to spend their time binning items after 8:00 AM. However, this time period can vary depending on the region, product, season, etc.

In example embodiments, the inventory rules engine generates a MPAS according to the following algorithm:

Ideal_Picks = Number of items manually picked between 6:00 AM and 11:00 AM by store
by week
Manual_Picks = Total number of items manually picked each hour by day by store by week
Picks_Adoption = SUM([Ideal_Picks]) / SUM([Manual_Picks]) * 100
if ISNULL([Picks_Adoption]) then 0

elseif [Picks_Adoption] > 50 then 10
elseif [Picks_Adoption] > 40 AND [Picks_Adoption] <=50 then 8
elseif [Picks_Adoption] > 30 AND [Picks_Adoption] <=40 then 6
elseif [Picks_Adoption] > 20 AND [Picks_Adoption] <=30 then 5
elseif [Picks_Adoption] <=20 then 2

end

As provided above, the MPAS can be generated based on a Picks_Adoption score, which is generated by determining the sum of all ideal picks performed during a week divided by the sum of all manual picks performed during a week, and multiplying that ratio by 100. For example, if the Picks_Adoption score is greater than 50, the MPAS can be 10; if the Picks_Adoption score is between 40 and 50, the MPAS can be 8; if the Picks_Adoption score is between 30 and 40, the MPAS can be 6; if the Picks_Adoption score is between 20 and 30, the MPAS can be 5; if the Picks_Adoption score is below 20, the MPAS can be 2; and if the Picks_Adoption score is zero, the MPAS can be zero. As will be appreciated, the various Picks_Adoption score ranges (e.g., a MPAS of 5 for the range of Picks_Adoption scores between 20-30) are provided for illustration purposes only and can be altered based on the characteristics of a particular store, season, region, etc. Likewise, the time periods used to identify Ideal_Picks can vary based on similar factors. For example, in this particular embodiment, the Ideal_Picks score is determined by the number of items manually picked between 6:00 AM and 11:00 AM because generally it is impractical for sales associates to spend their time performing manual picks outside of this time period. However, this time period can vary depending on the region, product, season, etc.

In example embodiments, the inventory rules engine generates a MCAS according to the following algorithm:

Non_Ideal_Counts = Number of items that were manually counted before 7:00 AM or
between 7:00 AM and 11:00 AM
Manual Counts = Total number of items manually counted each hour by store by week
Count Adoption = (SUM[Non_Ideal_Counts]) / SUM([Manual Counts])) * 100
if [Count_Adoption] is null then 0
elseif [Pick_Completion] <= 95 then

(

if [Count_Adoption] < 35 then 10
elseif [Count_Adoption] >= 35 AND [Count_Adoption] < 40 then 8
elseif [Count_Adoption] >= 40 AND [Count_Adoption] < 45 then 6
elseif [Count_Adoption] >= 45 AND [Count_Adoption] < 50 then 5
elseif [Count_Adoption] >= 50 AND [Count_Adoption] < 55 then 4
elseif [Count_Adoption] >= 55 then 2

end
)

elseif [Pick_Completion] > 95 then
(

if [Count_Adoption] < 50 then 10
elseif [Count_Adoption] >= 50 AND [Count_Adoption] < 55 then 8
elseif [Count_Adoption] >= 55 AND [Count_Adoption] < 65 then 6
elseif [Count_Adoption] >= 65 AND [Count_Adoption] < 70 then 5
elseif [Count_Adoption] >= 70 AND [Count_Adoption] < 75 then 4
elseif [Count_Adoption] >= 75 then 2

end
)

End

As provided above, the MCAS can be generated based on a Count_Adoption score, which is generated by determining the sum of all non-ideal counts performed during a week divided by the sum of all manual counts performed during a week, and multiplying that ratio by 100. If the Count_Adoption score is zero, then the MCAS can be zero. When the Count_Adoption score is non-zero, then the scaling of the MCAS may depend on how well a particular store is performing with respect to pick completion. For example, if the pick completion score for a given store is less than or equal to 95, then the following scaling can be used to determine the proper MCAS: if the Count_Adoption score is less than 35, the MCAS can be 10; if the Count_Adoption score is between 35 and 40, the MCAS can be 8; if the Count_Adoption score is between 40 and 45, the MCAS can be 6; if the Count_Adoption score is between 45 and 50, the MCAS can be 5; if the Count_Adoption score is between 50 and 55, the MCAS can be 4, and if the Count_Adoption score is above 55 the MCAS can be 2. However, if a store has a pick completion score greater than 95, then the following scaling can be used to determine the proper MCAS: if the Count_Adoption score is less than 50, the MCAS can be 10; if the Count_Adoption score is between 50 and 55, the MCAS can be 8; if the Count_Adoption score is between 55 and 65, the MCAS can be 6; if the Count_Adoption score is between 65 and 70, the MCAS can be 5; if the Count_Adoption score is between 70 and 75, the MCAS can be 4; and if the Count_Adoption score is greater than 75, the MCAS can be 2.

The various Pick_Adoption score ranges can vary, in some embodiments, depending on the characteristics of a particular store, region, etc. or depending on how well a store performs with respect to other operational health metrics. Likewise, the time frames used to identify Non_Ideal_Picks can vary based on the region, season, or other factors. In this particular example, the rules engine scales the MCAS differently depending on how well the particular store has performed on the Pick_Completion score. Specifically, a store is penalized less for performing non ideal picks if the Pick_Completion score (PCAS) is above 95. This scaling is implemented because, although sales associates are generally discouraged from performing manual counts before 7:00 AM or between 7:00 AM and 11:00 AM, the MCAS will not be decreased as significantly if the store maintains a high PCAS in spite of performing some manual counts during those time periods.

In example embodiments, the inventory rules engine generates a BAAS according to the following algorithm:

if ISNULL([Bin_Accuracy]) then 0

elseif [Bin_Accuracy]*100 > 90 then 10
elseif [Bin_Accuracy]*100 > 80 AND [Bin_Accuracy] <=90 then 9
elseif [Bin_Accuracy]*100 > 70 AND [Bin_Accuracy] <=80 then 7
elseif [Bin_Accuracy]*100 > 60 AND [Bin_Accuracy] <=70 then 6
elseif [Bin_Accuracy]*100 > 50 AND [Bin_Accuracy] <=60 then 5
elseif [Bin_Accuracy]*100 <=50 then 3

end

As provided above, the BAAS can be generated based on a Bin_Accuracy score, which is a score determined by a physical audit of a bin or storage location comparing expected content to actual content. For example, if the Bin_Accuracy score is greater than 0.90, the BAAS can be 10; if the Bin_Accuracy score is between 0.80 and 0.90, the BAAS can be 9; if the Bin_Accuracy score is between 70 and 80, the BAAS can be 7; if the Bin_Accuracy score is between 60 and 70, the BAAS can be 6; if the Bin_Accuracy score is between 50 and 60, the BAAS can be 5; if the Bin_Accuracy score is below 50, the BAAS can be 3; and if the Bin_Accuracy score is zero, the BAAS can be zero. As will be appreciated, the various Bin_Accuracy score ranges (e.g., a BAAS of 5 for the range of pick completion scores between 50-60) are provided for illustration purposes only and can be altered based on the characteristics of a particular store, season, region, or any other suitable factor. The score ranges, and other weighting values of the algorithms described above can be developed using historical store data and can be updated or refined periodically, in some embodiments.

In step 108, an exemplary IMS can input store activity data into an operational rules engine. The operational rules engine can be programmed to generate an operational health score for each of the plurality of stores corresponding to the previously calculated adoption scores associated with each store.

In step 110, an exemplary IMS can generate an operational health score for each store. In some embodiments, the operational rules engine is programmed to execute operational rules to statistically weight each adoption score and operational health metric based on the overall on-shelf-availability and operational health of a store. For example, if it is determined that pick completion has a much higher impact on on-shelf-availability than bin accuracy, the PCAS can be weighted much heavier than the BAAS when calculating the overall operational health score for each store. The various weighting values can be determined based on historical store data and can be periodically updated or adjusted. In example embodiments, the operational health score (OHS) can be calculated according to equation (1) below.

OHS=W₁*PCAS+W₂*MCAS+W₃*IBAS+W₄*MPAS+0.05*BAAS (1)

In the above equation, W₁-W₄ represent weighting values that are applied to the adoption scores such that some have a greater contribution to the operational health score than other adoption scores. As a non-limiting example, in some embodiments, W₁ can be about 0.40, W₂ can be about 0.25, W₃ can be about 0.15, and W₄ can be about 0.15. In step 112, an exemplary IMS 100 can write the store activity data, adoption scores, and operational health scores into a database to store the data in physical memory locations of a computer-readable medium. In some embodiments, the database can be located remotely on one or more servers via a distributed network environment. The database can then store this information so that it can be retrieved from the physical memory of the computer-readable medium and/or can be transmitted to an electronic display device in response to a query that is constructed in response to input from a user. In some embodiments, the store activity data collected via the sensors may be temporarily stored locally at the stores, or may be automatically saved to the database.

In step 114, an exemplary IMS can construct a database query. The database query can be initiated based user inputs received in response to an interaction with GUI(s) rendered on the electronic display device. The database query can include a request, in a database language (e.g., SQL), to the database for either the score activity data, one or more adoption scores, or one or more operational health scores. This database query can be transmitted over a wired or wireless network and can prompt a remote server to access the database, retrieve the requested information from physical memory locations, and transmit the desired information to the electronic display device.

In step 116, an exemplary IMS can transmit the requested information from the database to the electronic display device for incorporation into a GUI rendered by the electronic display device. The information transmitted from the database corresponds to the information requested via the database query described above, and can include store activity data, one or more adoption score, or one or more operational health score, in some embodiments.

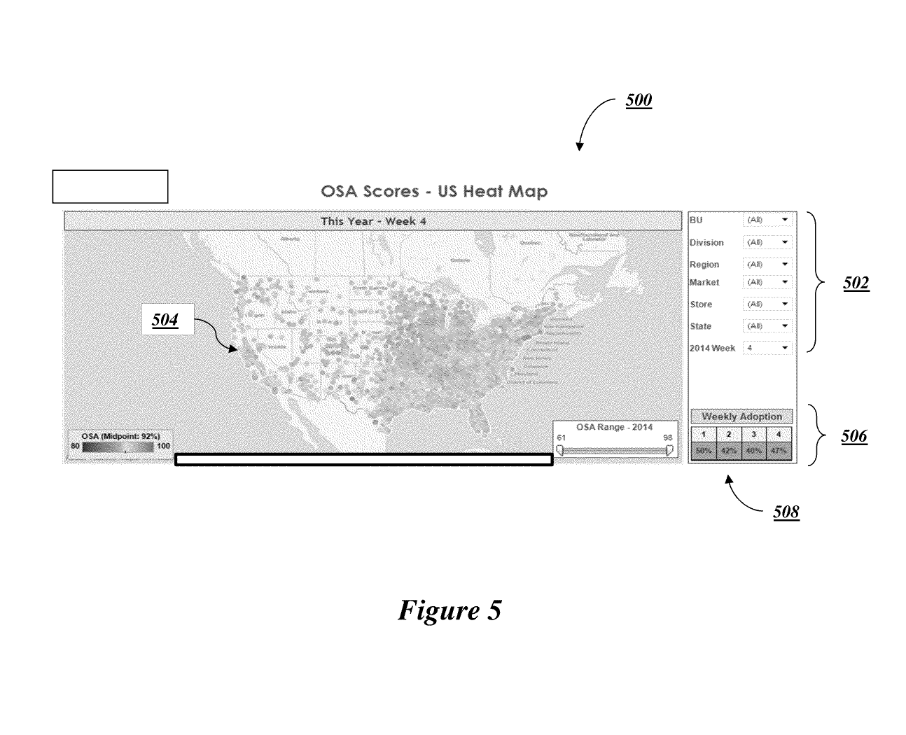

In step 118, an exemplary IMS can render a GUI on the electronic display device to display a graphical indicators representative of the operational health scores of each store overlaid on a geographic map. Each graphical indicator can be representative of the operational health score and the geographic location of a particular store. In some embodiments, the GUI is also programmed to display an on-shelf-availability score heat map including a number of on-shelf-availability store icons that represent the on-shelf-availability score and geographical location of a number of stores. In some embodiments, the geographical indicators can be color coded to represent the operational health score of the stores. For example, a store with an above-average operational health score can be assigned a green store icon in the GUI, a store with an average operational health score can be assigned a yellow store icon in the GUI, and a store with a below-average operational health score can be assigned a red store icon in the GUI. The GUI can be a touch-screen UI, in some embodiments, and can include a capacitive or resistive touch sensitive display. The graphical indicators displayed on the geographical map can be, in some embodiments, selectable icons that a user can select via a pointing device such as a finger, pen, stylus, mouse cursor, or trackpad cursor. As discussed further in reference to FIGS. 5-13, the GUI can also provide a number of other user interface (UI) features such as a zooming function, detailed metrics tables and/or charts, or a top stores and bottom stores listing.

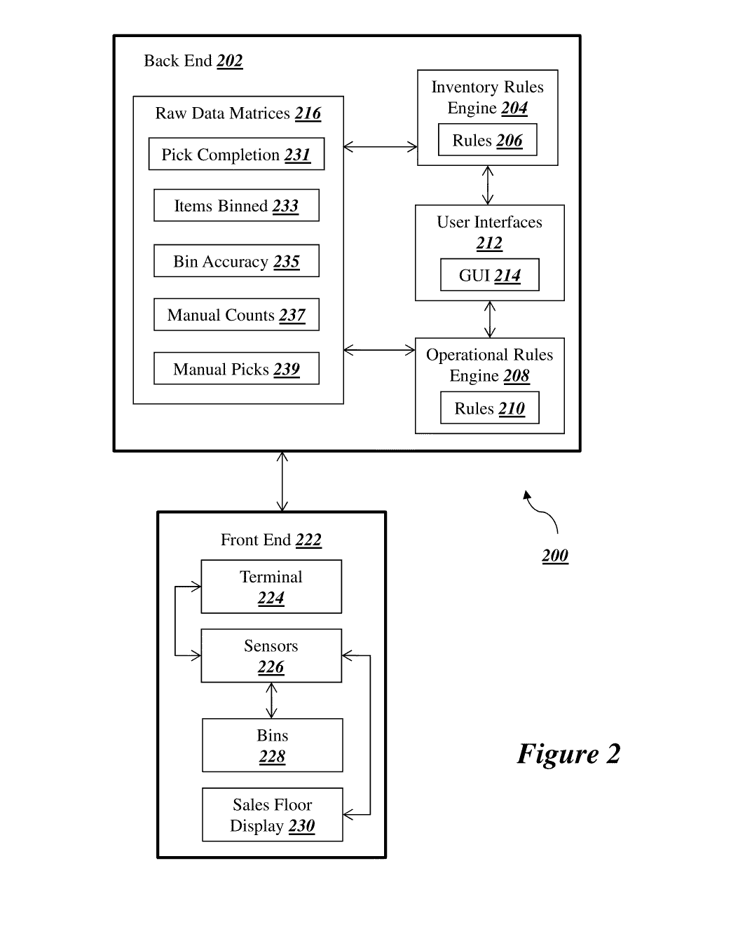

FIG. 2 is a block diagram of an exemplary inventory management system 200 that can be used to perform any of the exemplary methods disclosed herein. Specifically, the system 200 includes a back end 202 configured to receive store data 210 from one or more stores. The store data can correspond to one or more health metrics such as, for example, pick completion, items binned, bin accuracy, manual counts, and manual picks. The back end 202 includes raw data matrices or databases 216 for storing the store activity data such as pick completion 231, items binned 233, bin accuracy 235, manual counts 237, and manual picks 239. The back end 202 also includes an inventory rules engine 204 for determining adoption scores corresponding to each operational health metric based on a set of inventory rules 206. In exemplary embodiments, the rules 206 can be a one or more algorithms and/or conditional statements that can be executed by the engine 204 in response to the operational health metrics received by the engine 204. The back end 202 also includes an operational rules engine 208 for calculating an operational health score for each store based on a second set of operational rules 210. In exemplary embodiments, the rules 210 can be a one or more conditional statements that can be executed by the engine 208 in response to the operational health metrics received by the engine 208. Once calculated, the adoption scores and operational health scores are stored in the database 208. Users can interact with the system 200 via an electronic display device. The back end can also include one or more user interfaces 212, including a GUI 214 that can be rendered by the electronic display device.

The system 200 can include a front end 222 that is in communication with the back end to facilitate the generation of store activity data corresponding to operational health metrics. In exemplary embodiments, the front end can include one or more computer terminals 224, sensors 226, bins 228, and sales floor displays 230. The one or more computer terminals can be configured to facilitate communication with the back end 202 and to receive inputs corresponding to store activity data. The sensors 226 can be positioned in proximity to the bins 228 or displays 230, and can detect store activity data, such as, when items are placed in bins or on displays, what types of items are on bins or displays, or any other relevant store activity or inventory data. For example, in some embodiments the sensors can be radiofrequency identification (RFID) readers that can monitor RFID tags associated with and/or affixed to items/products in the bins 228 and/or displays 230. When an employee removes an item from a bin or display 230 (places an item in a bin or display), the RFID reader can sense the RFID tag affixed to the item and can generate an electronic signal that is transmitted to the one or more terminals 224 as store activity data, and the one or more terminals can associate the store activity data with one or more operational metrics, e.g., one of a pick completion, an item binned, bin accuracy, a manual count, and/or a manual pick. In other embodiments, the sensors can be barcode scanners, either at a point of sale terminal or within a handheld device carried by a sales associate, that can scan and record product data and/or store activity data. The front end 222 can be in communication with the back end 202 via a wired or wireless network, and the store activity data collected at the front end 222 may be transferred, either automatically or manually, to the back end 202 to be stored in one of the raw data matrices 216.

### IV. Exemplary Computing Devices

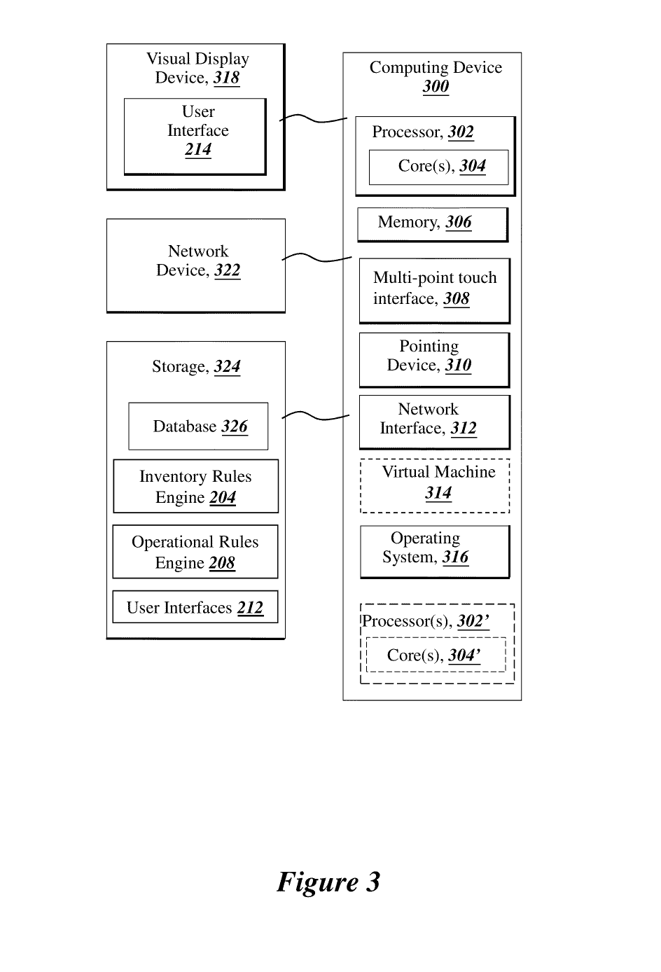

FIG. 3 is a block diagram of an exemplary computing device 300 that can be used to perform any of the methods provided by exemplary embodiments. The computing device 300 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more USB flashdrives), and the like. For example, memory 306 included in the computing device 300 can store computer-readable and computer-executable instructions or software for implementing exemplary embodiments. The computing device 300 also includes processor 302 and associated core 304, and optionally, one or more additional processor(s) 302′ and associated core(s) 304′ (for example, in the case of computer systems having multiple processors/cores), for executing computer-readable and computer-executable instructions or software stored in the memory 306 and other programs for controlling system hardware. Processor 302 and processor(s) 302′ can each be a single core processor or multiple core (304 and 304′) processor.

Virtualization can be employed in the computing device 300 so that infrastructure and resources in the computing device can be shared dynamically. A virtual machine 314 can be provided to handle a process running on multiple processors so that the process appears to be using only one computing resource rather than multiple computing resources. Multiple virtual machines can also be used with one processor.

Memory 306 can include a computer system memory or random access memory, such as DRAM, SRAM, EDO RAM, and the like. Memory 306 can include other types of memory as well, or combinations thereof.

A user can interact with the computing device 300 through a visual display device 318, such as a touch screen display or computer monitor, which can display one or more user interfaces 214 that can be provided in accordance with exemplary embodiments, for example, the exemplary interfaces illustrated in FIGS. 5-13. The visual display device 318 can also display other aspects, elements and/or information or data associated with exemplary embodiments, for example, views of databases, maps, tables, graphs, charts, and the like. The computing device 300 can include other I/O devices for receiving input from a user, for example, a keyboard or any suitable multi-point touch interface 308, a pointing device 310 (e.g., a pen, stylus, mouse, or trackpad). The keyboard 308 and the pointing device 310 can be coupled to the visual display device 318. The computing device 300 can include other suitable conventional I/O peripherals.

The computing device 300 can also include one or more storage devices 324, such as a hard-drive, CD-ROM, or other computer readable media, for storing data and computer-readable instructions and/or software, such as the inventory rules engine 204, operational rules engine 208, and/or user interfaces 212, that implement exemplary embodiments of the inventory management system 200 as taught herein or portions thereof. Exemplary storage device 324 can also store one or more databases for storing any suitable information required to implement exemplary embodiments. The databases can be updated by a user or automatically at any suitable time to add, delete or update one or more items in the databases. Exemplary storage device 324 can store one or more databases 326 for storing store activity data, adoption scores, operational health scores, any suitable maps or mapping information on one or more geographical areas where the stores of interest can be located, and any other data/information used to implement exemplary embodiments of the inventory management system.

The computing device 300 can include a network interface 312 configured to interface via one or more network devices 322 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. The network interface 312 can include a built-in network adapter, network interface card, PCMCIA network card, card bus network adapter, wireless network adapter, USB network adapter, modem or any other device suitable for interfacing the computing device 300 to any type of network capable of communication and performing the operations described herein. Moreover, the computing device 300 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 300 can run any operating system 316, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 316 can be run in native mode or emulated mode. In an exemplary embodiment, the operating system 316 can be run on one or more cloud machine instances.

### V. Exemplary Network Environments

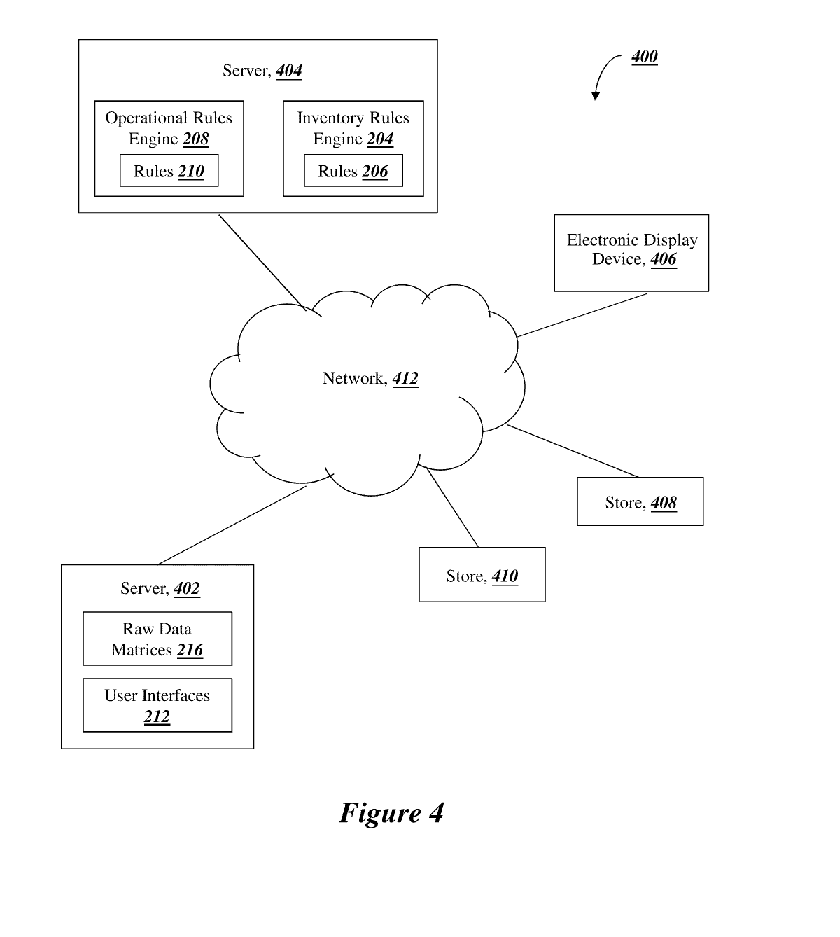

FIG. 4 is a diagram of an exemplary network environment 400 suitable for a distributed implementation of exemplary embodiments. The network environment 400 can include one or more servers 402 and 404 that can include the operational rules engine 208, inventory rules engine 204, raw data matrices or database 216, user interfaces 212, or other elements described in reference to FIG. 2 above. In exemplary embodiments, the server 404 can include the inventory rules engine 204 for calculating adoption scores based on a first set of rules 206, as well as the operational rules engine 208 for calculating operational health scores based on a second set of rules 210, while the server 402 includes the raw data matrices 216 and user interfaces 212. As will be appreciated, various distributed or centralized configurations may be implemented, and in some embodiments a single server can be used. The network environment can also include a number of stores 408 and 410, which may include the sensors, computer terminals, and/or other front end elements described in reference to FIG. 2. The network environment may also include an electronic display device 406 that can display the GUI to a user. In exemplary embodiments, the servers 402 and 404, stores 408 and 410, and the electronic display device may be in communication with each other via a communication network 412. The communication network 412 may include, but is not limited to, the Internet, an intranet, a LAN (Local Area Network), a WAN (Wide Area Network), a MAN (Metropolitan Area Network), a wireless network, an optical network, and the like. The electronic display device 406 that is in communication with the servers 402 and 404 can generate and transmit a database query requesting information from the raw data matrices or database 216. The requested information can include, for example, store activity data, one or more adoption scores, or one or more operational health scores. Once the electronic display device 406 receives the requested store information from the servers 402 and 404, the device 406 can display a GUI to the user presenting one or more graphical indicators or icons, corresponding to the on-shelf-availability and/or operational health of one or more stores, overlaid on a geographic map.

### VI. Exemplary Graphical User Interfaces

FIG. 5 depicts an exemplary user interface that can be generated and populated in accordance with exemplary embodiments of the present disclosure for displaying on-shelf-availability of inventory using a heat map 500. The on-shelf-availability score, operational health score, and any other data provided to the user via the GUI and heat map 500 can be filtered or narrowed using one or more quick filters 502, including business unit (BU), division, region, market, state, store, week, department, category, etc. For example, the on-shelf-availability score and/or operational health score can be restricted to the category of dry soup or infant consumables within the dry grocery department in order to determine the health of each store with respect to this particular category of goods. In some embodiments, each of the quick filters displays values in context with the other filters. For example, if the first selection is Division A, then only regions in Division A will appear in the Region filter; only Markets in the regions that belong to Division A will appear in the Market filter, and so on. As shown in FIG. 5, each graphical indicator 504 is a selectable UI icon that is color coded to reflect the on-shelf-availability score corresponding to each store. Specifically, the graphical indicators 504 can be shaded darker, or higher on the red-scale, if they are have a below average on-shelf-availability score. The GUI can also include a “Weekly Adoption” table 506 listing the average adoption percentages 508 for a number of weeks. In this example, the average adoption scores for weeks 1-4 are displayed with 50% of stores meeting the desired on-shelf-availability score in week 1, 42% of stores meeting the desired on-shelf-availability score in week 2, 40% of stores meeting the desired on-shelf-availability score in week 3, and 47% of stores meeting the desired on-shelf-availability score in week 4.

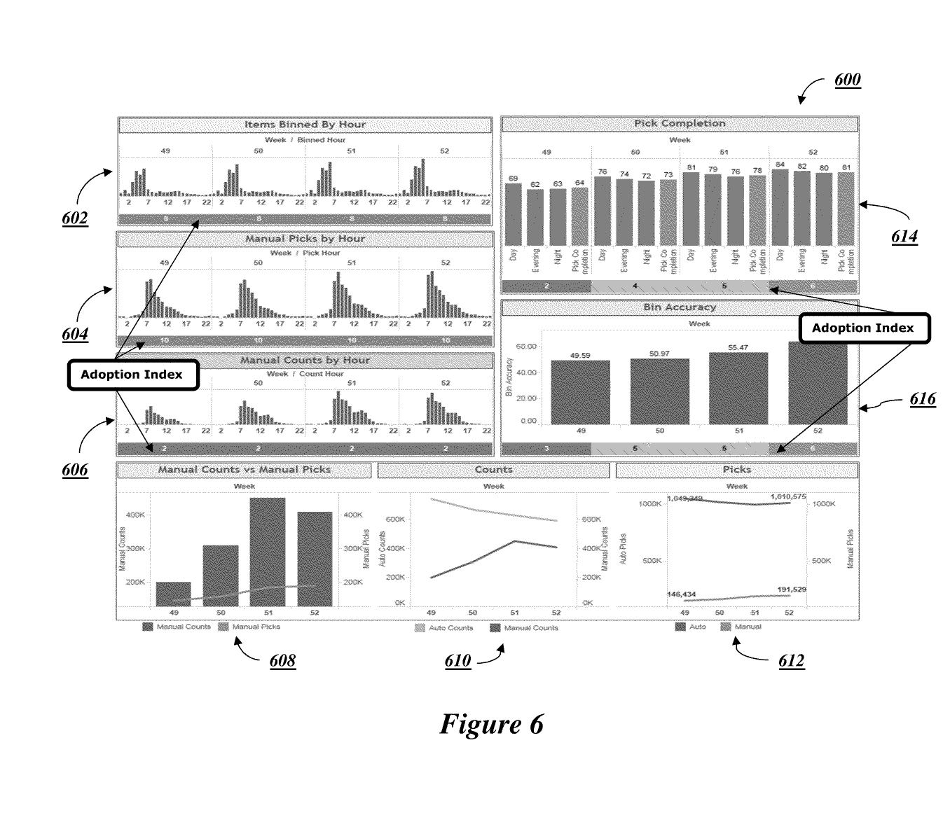

FIG. 6 depicts an exemplary user interface that can be generated in accordance with exemplary embodiments of the present disclosure for displaying store activity data and operational health metric data. More detailed information regarding the on-shelf-availability score and/or operational health of one or more stores can be displayed to the user via a Metrics Table 600. The table 600 can include various charts, graphs, and adoption indices corresponding to key operational health metrics. For example, chart 602 shows items binned by hour, chart 604 shows manual picks by hour, chart 606 shows manual counts by hour, chart 614 shows pick completion by week, chart 616 shows bin accuracy, chart 608 shows manual counts vs. manual picks, graph 610 shows total counts (both manual and automatic), and graph 612 shows total picks (both manual and automatic). As described above, each of these charts, graphs, and tables can be filtered using one or more of the quick filters 502. Additionally, the operational health metrics of a single store or a group of stores can be presented by selecting one or more of the graphical indicators 504. Once selected, the GUI can display the operational health score, process adoption score information, a graph of operational health metric data, an on-shelf-availability score, a process adoption score by market, a weekly adoption score, an information comparison chart (e.g., comparing the current on-shelf-availability score or operational health score compared to previous scores), or other store data corresponding to the one or more selected graphical indicators.

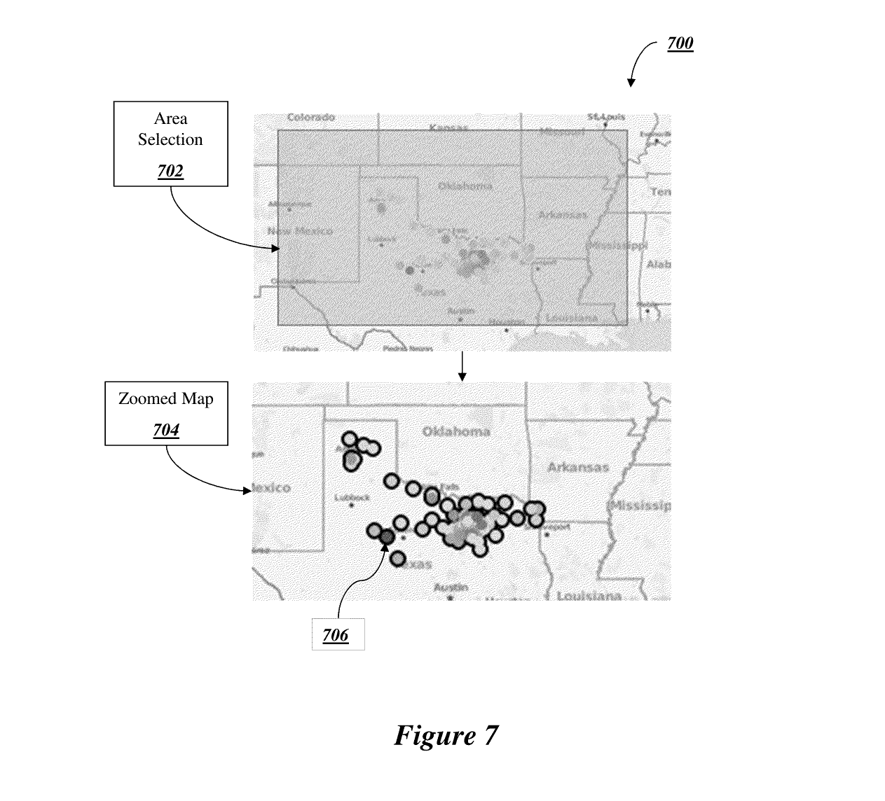

FIG. 7 depicts an exemplary user interface that can be generated in accordance with exemplary embodiments of the present disclosure for zooming in on an area of a heat map. As shown in FIG. 7, a geographical map 700 displays a geographical area, and a user can select a smaller area 702 using one or more user input commands. The zoom in function can be performed, for example, via a double-click, double-tap gesture or some other identifiable gesture performed on a touchscreen or trackpad, selecting a “zoom” control icon located on the screen or keyboard, or some other combination of user input commands (e.g., holding the Shift key and performing a double-click or click-and-drag command with a mouse). Once an area selection 702 has been made, or a zoom in command has been performed, the zoomed in map 704 is displayed below, along with the color-coded graphical indicators 706 corresponding to that area of the map.

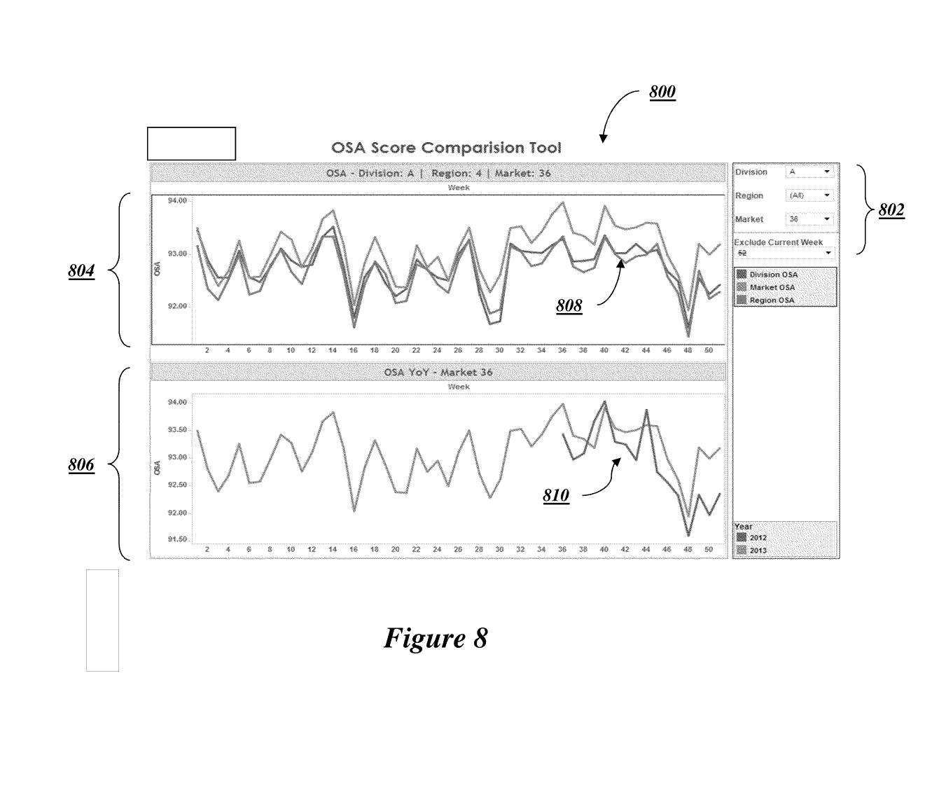

FIG. 8 depicts an exemplary user interface that can be generated in accordance with exemplary embodiments of the present disclosure for comparing inventory on-shelf-availability scores. As described above, the GUI can display a comparison tool 800 so that the user can view the on-shelf-availability score, operational health score, or other health metric scores of one or more stores compared to previous scores or other business categories. The various business categories, such as division, region, market, etc., can be selected using a quick filter 802. As shown in FIG. 8, comparison graph 804 shows three data lines 808 corresponding to the on-shelf-availability score for a particular division, region, and market selected via the quick filters 802. The on-shelf-availability scores are charted from weeks 1-51 within a particular year. The comparison tool 800 also includes a year-to-year graph 806 including data lines 810 that can be used for comparing the on-shelf-availability scores from weeks 36-51 of the current year for a particular market (Market 36, in this example) with the on-shelf-availability scores from the previous year for that same market. As will be appreciated, the comparison tool 800 GUI feature can be implemented to display and compare on-shelf-availability scores, operational health scores, adoption scores, store activity date, etc. and can be filtered or narrowed to only include data from a specific business unit, division, region, market, state, store, department, category, etc.

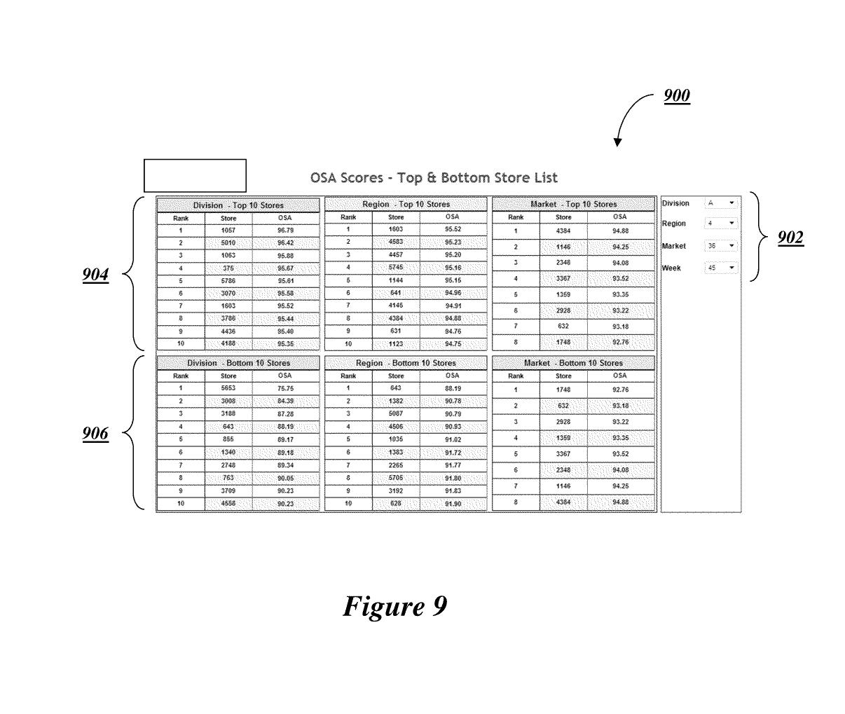

FIG. 9 depicts an exemplary user interface that can be generated in accordance with exemplary embodiments of the present disclosure for displaying a top and bottom stores list. In this embodiment, the store listing table 900 includes a listing of the top 10 stores 904 is displayed for a selected division, region, and market. A second listing of the bottom 10 stores 906 is displayed for a selected division, region, and market. The desired division, region, market, or other filter options can be selected using one or more quick filters 902. As will be appreciated, other filters can include, for example, business unit, state, department, category, etc. or no filters can be selected in order to view the overall best and worst stores. The top 10 stores 904 and bottom stores 906 for each division, region, and market are based on each store's on-shelf-availability scores. The store listing table 900 can also display a listing of the top and bottom stores with respect to their operational health scores or other operational health metrics.

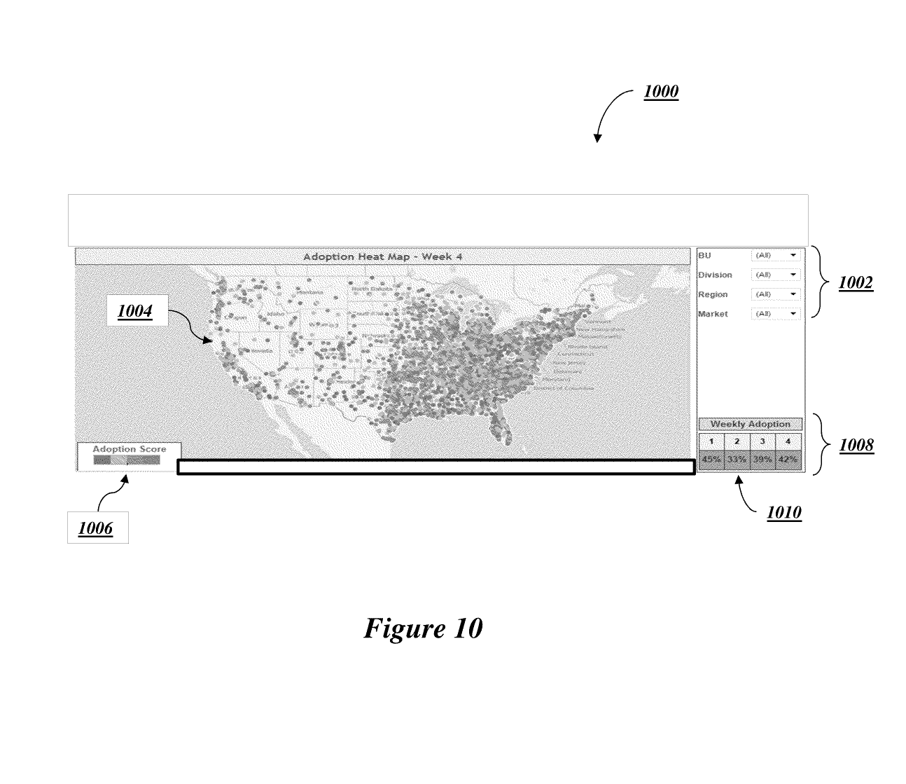

FIG. 10 depicts an exemplary user interface that can be generated in accordance with exemplary embodiments of the present disclosure for displaying operational health scores of stores using a heat map. As shown in FIG. 10, the process adoption heat map 1000 can be filtered using one or more quick filters 1002 including business unit, division, region, market, state, store, week, department, category, etc., as discussed in reference to FIG. 5. For example, the operational health scores or process adoption scores can be restricted to a particular category or department in order to determine the health of each store with respect to that category of goods or department. The GUI can also include a “Weekly Adoption” table 1008 listing the average adoption scores 1010 for a number of weeks. In this example, the average adoption scores for weeks 1-4 are displayed and each graphical indicator 1004 is compared with the weekly average and color-coded appropriately. The adoption score scale 1006 shows the color scale for each of the graphical indicators 1004. As discussed in reference to FIG. 7, a user can zoom in or out on specific areas of the heat map 1000 via various user input commands.

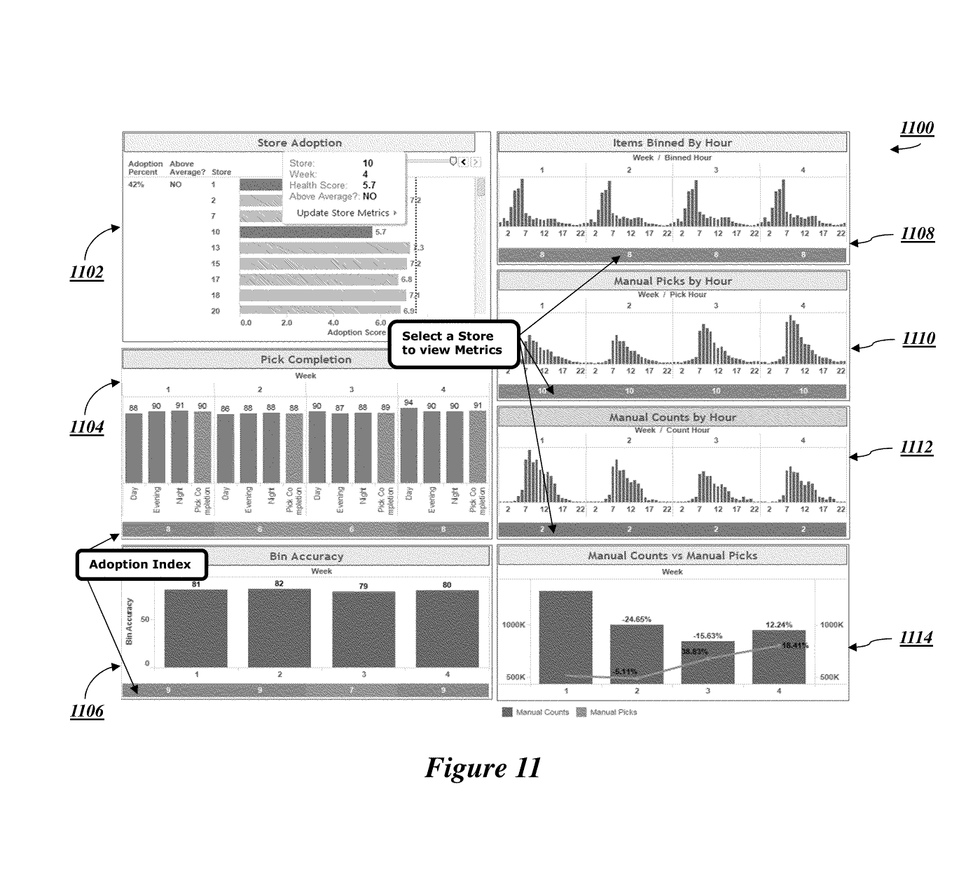

FIG. 11 depicts an exemplary user interface that can be generated in accordance with exemplary embodiments of the present disclosure for displaying store activity data and store adoption score data. More detailed information regarding the operational health scores and/or adoption scores of one or more stores can be displayed to the user via a metrics table 1100. One or more stores can be selected on the heat map 1000 using a finger, stylus, mouse, etc., and key metrics for the selected stores are then presented to the user in the metrics table 1100. If no stores are selected, the metrics table 1100 can display detailed operational health information regarding all stores currently displayed on the heat map 1000. In one embodiment, individual stores can be selected using a “Store Adoption” section of the metrics table 1100 by hovering a cursor such as a finger, stylus, mouse cursor, etc., over any store adoption index and selecting an “update store metrics” option or other similar option presented via the GUI. This technique allows a user to easily view key metrics for a particular store. In other embodiments, a group of stores categorized as “above average” (i.e., having an operational health score or adoption score above a regional, national, market-wide, or other average), or “below average” can be selected and displayed. The table 1100 includes various charts, graphs, and adoption indices corresponding to key operational health metrics. For example, chart 1102 shows store adoption scores, chart 1104 shows pick completion by week, chart 1106 shows bin accuracy by week, chart 1108 shows items binned by hour, chart 1110 shows manual picks by hour, chart 1112 shows manual counts by hour, and chart 1114 shows manual counts vs. manual picks.

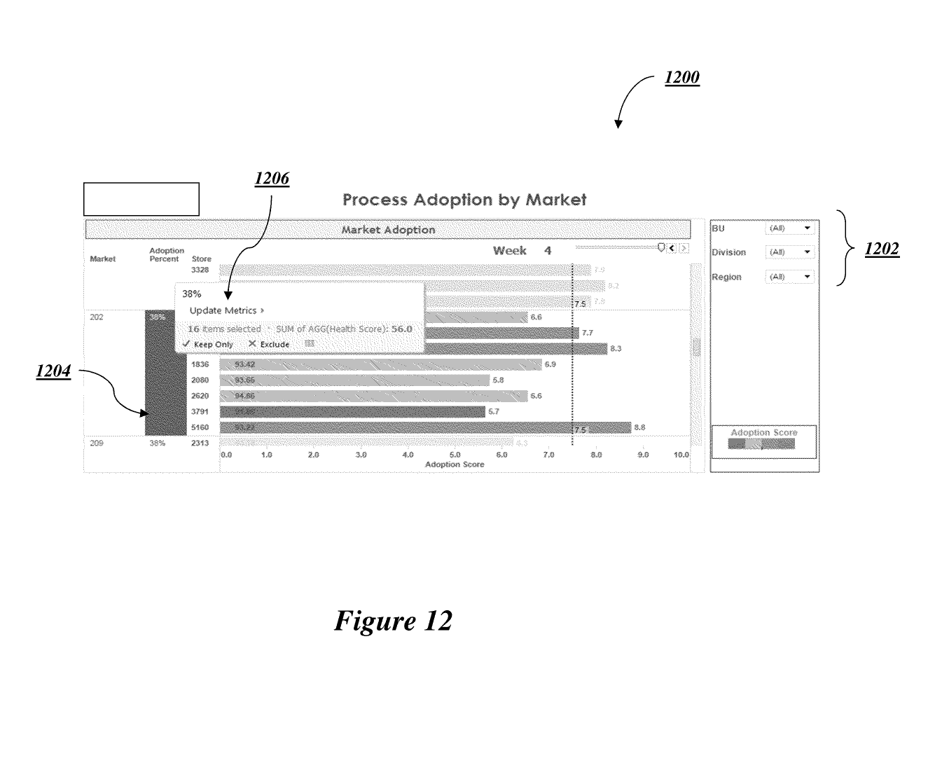

FIG. 12 is depicts an exemplary user interface that can be generated in accordance with exemplary embodiments of the present disclosure for displaying process adoption data by market. In this embodiment, the process adoption chart by market 1200 can be filtered by business unit, division, region, or other filters using one or more filters 1202. The chart 1200 can also display the overall adoption percentage by market, the on-shelf-availability scores for particular stores, as well as the operational health scores for each store. As will be appreciated, the chart 1200 can be filtered by a particular week or group of weeks. Similarly, process adoption charts, such as the adoption percent score chart 1204, can be generated for a given business unit, division, region, state, department, category, etc. The chart 1200 or GUI tab can display markets in an ascending or descending order based on their adoption percent score. In one embodiment, markets with the lowest adoption percent will be displayed on top while those with the highest adoption percent will be displayed at the bottom. Individual stores and/or markets can then be selected using one or more user input commands. For example, a user can hover a mouse cursor over a particular store adoption index, or perform a left-click or similar command using a mouse or trackpad, and selecting an “update store metrics” option 1206.

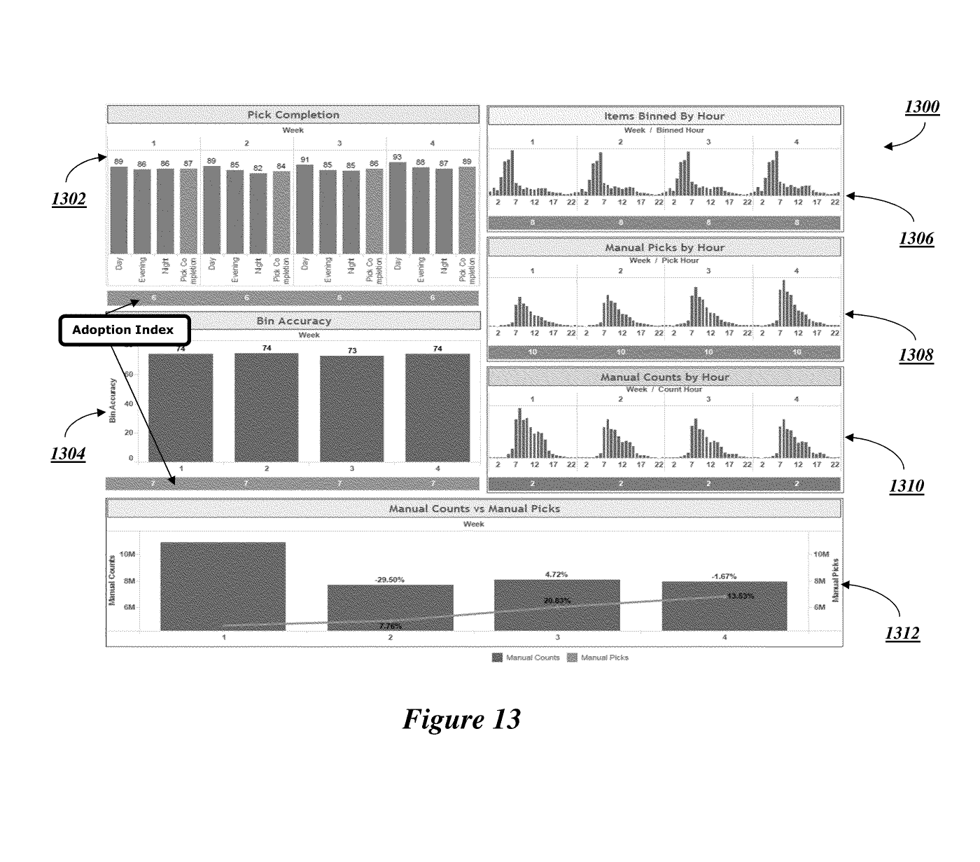

FIG. 13 depicts an exemplary user interface that can be generated in accordance with exemplary embodiments of the present disclosure for displaying store activity data and key process adoption metrics. More detailed information regarding the operational health and process adoption scores of one or more stores can be displayed to the user via a Metrics Table 1300. The table 1300 includes various charts, graphs, and adoption indices corresponding to key operational health metrics. For example, chart 1302 shows pick completion by week, chart 1304 shows bin accuracy by week, chart 1312 shows manual counts vs. manual picks, chart 1306 shows items binned by hour, chart 1308 shows manual picks by hour, and chart 1310 shows manual counts by hour. As described above, each of these charts, graphs, and tables can be filtered using one or more of the quick fillers similar to the filters 1002 described in FIG. 10.

### VII. Equivalents

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component or step. Likewise, a single element, component or step can be replaced with a plurality of elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

What is claimed is:

1. In an inventory management system a method of translating physical activities within one or more stores into reference data corresponding to an operational health of the one or more stores, the method comprising:
receiving at a server of the inventory system, store activity data in an electronic format representing physical inventory processing tasks at a plurality of stores and corresponding to operational metrics associated with on-shelf-availability of products within the plurality of stores;
inputting the store activity data into an inventory rules engine programmed to generate and output a plurality of adoption scores based on the store activity data and one or more inventory rules, wherein each adoption score is a performance grade of one of the plurality of stores with respect to one of the operational metrics;
inputting the plurality of adoption scores into an operational rules engine programmed to generate and output an operational health score for each of the plurality of stores, wherein each operational health score is statistically determined based on the plurality of adoption scores associated with one of the plurality of stores and one or more operational rules;
writing the store activity data, the plurality of adoption scores, and operational health score for each of the plurality of stores into a database;
constructing a database query via an electronic display device to retrieve from the database at least one of the store activity data, the plurality of adoption scores, or the operational health score;
transmitting at least one of the store activity data, the plurality of adoption scores, or operational health score from the database to the electronic display device; and
rendering on the electronic display device a graphical user interface programmed to display a plurality of graphical indicators programmatically overlaid on a geographic map, each graphical indicator representative of the operational health score and geographical location of one of the plurality of stores.

2. The method of claim 1, wherein the graphical user interface is further programmed to display an on-shelf-availability score heat map including a plurality of on-shelf-availability store icons representing the on-shelf-availability score and geographical location of each of the plurality of stores.

3. The method of claim 1, wherein the operational health score for each of the plurality of stores corresponds to a weighted sum of a pick completion adoption score (PCAS), a manual counts adoption score (MCAS), a manual pick adoption score (MPAS), an items binned adoption score (IBAS), and a bin accuracy adoption score (BAAS), wherein the PCAS is given most weight and the BAAS is given least weight.

4. The method of claim 1, wherein the plurality of graphical indicators are color coded to represent the operational health score of a single store.

5. The method of claim 1, wherein the plurality of graphical indicators comprise a plurality of user interface store icons selectable by a pointing device.

6. The method of claim 5, wherein the graphical user interface is further programmed to render, in response to a user selection of one of the store icons, at least one of an operational health score, process adoption score, a graph of operational metric data, an on-shelf-availability score, a process adoption by market, or a weekly adoption score corresponding to the selected store icon.

7. The method of claim 1, wherein the plurality of graphical indicators are color coded to represent whether the operational health score corresponding to each store is above or below a threshold operational health score.

8. The method of claim 7, wherein the store icons comprise an operational health score heat map of the plurality of stores.

9. The method of claim 8, wherein the graphical user interface is further programmed to display a first listing of stores rated highest by the operational health score and a second listing of stores rated lowest by the operational health score.

10. A system of translating physical activities within one or more stores into reference data corresponding to an operational health of the one or more stores, the system comprising:
a server of the inventory system programmed to:
receive store activity data in an electronic format representing physical inventory processing tasks at a plurality of stores and corresponding to operational metrics associated with on-shelf-availability of products within the plurality of stores; input the store activity data into an inventory rules engine programmed to generate and output a plurality of adoption scores based on the store activity data and one or more inventory rules, wherein each adoption score is a performance grade of one of the plurality of stores with respect to one of the operational metrics;
input the plurality of adoption scores into an operational rules engine programmed to generate and output an operational health score for each of the plurality of stores, wherein each operational health score is statistically determined based on the plurality of adoption scores associated with one of the plurality of stores and one or more operational rules; and
write the store activity data, the plurality of adoption scores, and operational health score for each of the plurality of stores into a database; and
an electronic display device programmed to:
construct a database query requesting from the database at least one of the store activity data, the plurality of adoption scores, or the operational score;
receive at least one of the store activity data, the plurality of adoption scores, or the operational score from the database in response to the database query; and
render, via a graphical user interface, a plurality of graphical indicators programmatically overlaid on a geographic map, each graphical indicator representative of the operational health score and geographical location of one of the plurality of stores.

11. The system of claim 10, wherein the graphical user interface is further programmed to display an on-shelf-availability score heat map including a plurality of on-shelf-availability store icons representing the on-shelf-availability score and geographical location of each of the plurality of stores.

12. The system of claim 10, wherein the operational health score for each of the plurality of stores corresponds to a weighted sum of a pick completion adoption score (PCAS), a manual counts adoption score (MCAS), a manual pick adoption score (MPAS), an items binned adoption score (IBAS), and a bin accuracy adoption score (BAAS), wherein the PCAS is given most weight and the BAAS is given least weight.

13. The system of claim 10, wherein the plurality of graphical indicators are color coded to represent the operational health score of a single store and comprise a plurality of user interface store icons selectable by a pointing device, the graphical user interface of the electronic display device being further programmed to render, in response to a user selection of one of the store icons, at least one of an operational health score, a process adoption score, a graph of operational metric data, an on-shelf-availability score, process adoption by market, or a weekly adoption score corresponding to the selected store icon.

14. The system of claim 10, wherein the plurality of graphical indicators are color coded to represent whether the operational health score corresponding to each store is above or below a threshold operational health score, and wherein the store icons comprise an operational health score heat map of the plurality of stores.

15. A non-transitory computer readable medium storing instructions executable by a processing device, wherein execution of the instructions causes the processing device to implement a method of translating physical activities within one or more stores into reference data corresponding to an operational health of the one or more stores comprising:
receiving at a server store activity data in an electronic format representing physical inventory processing tasks at the plurality of stores and corresponding to operational metrics associated with on-shelf-availability of products within the plurality of stores;
inputting the store activity data into an inventory rules engine programmed to generate and output a plurality of adoption scores based on the store activity data and one or more inventory rules, wherein each adoption score is a performance grade of one of the plurality of stores with respect to one of the operational metrics;
inputting the plurality of adoption scores into an operational rules engine programmed to generate and output an operational health score for each of the plurality of stores, wherein each operational health score is statistically determined based on the plurality of adoption scores associated with one of the plurality of stores and one or more operational rules;
writing the store activity data, the plurality of adoption scores, and operational health score for each of the plurality of stores into a database;
constructing a database query via an electronic display device requesting from the database at least one of the store activity data, the plurality of adoption scores, or the operational health score;
transmitting at least one of the store activity data, the plurality of adoption scores, or operational health score from the database to the electronic display device; and
rendering a graphical user interface on the electronic display device programmed to display a plurality of graphical indicators programmatically overlaid on a geographic map, each graphical indicator representative of the operational health score and geographical location of one of the plurality of stores.

16. The non-transitory computer readable medium of claim 15, wherein the graphical user interface is further programmed to display an on-shelf-availability score heat map including a plurality of on-shelf-availability store icons representing the on-shelf-availability score and geographical location of each of the plurality of stores.

17. The non-transitory computer readable medium of claim 15, wherein the operational health score for each of the plurality of stores corresponds to a weighted sum of a pick completion adoption score (PCAS), a manual counts adoption score (MCAS), a manual pick adoption score (MPAS), an items binned adoption score (IBAS), and a bin accuracy adoption score (BAAS), wherein the PCAS is given most weight and the BAAS is given least weight.

18. The non-transitory computer readable medium of claim 15, wherein the plurality of graphical indicators are color coded to represent the operational health score of a single store and comprise a plurality of user interface store icons selectable by a pointing device, the graphical user interface being further programmed to render, in response to a user selection of one of the store icons, at least one of an operational health score, process adoption score, a graph of operational metric data, an on-shelf-availability score, a process adoption by market, or a weekly adoption score corresponding to the selected store icon.

19. The non-transitory computer readable medium of claim 15, wherein the plurality of graphical indicators are color coded to represent whether the operational health score corresponding to each store is above or below a threshold operational health score, and wherein the store icons comprise an operational health score heat map of the plurality of stores.

20. The non-transitory computer readable medium of claim 19, wherein the graphical user interface is further programmed to display a first listing of stores rated highest by the operational health score and a second listing of stores rated lowest by the operational health score.
